(19) United States
(12) Patent Application Publication
(10) Pub. No.: US 2017/0099982 A1
(43) Pub. Date: Apr. 13, 2017

(54) SOLENOID PUMP MOUNTING METHOD

(71) Applicant: Flow Control LLC, Beverly, MA (US)

(72) Inventor: Jeffrey D. LOPES, Gloucester, MA (US)

(21) Appl. No.: 15/290,374

(22) Filed: Oct. 11, 2016

Related U.S. Application Data
(60) Provisional application No. 62/238,775, filed on Oct. 8, 2015.

(51) Int. Cl. A47J 31/46; F16M 13/02

(52) U.S. Cl. CPC A47J 31/46; F16M 13/02

(57) ABSTRACT

A pump mounting system for mounting a pump to a beverage dispensing system, featuring a pump having a housing configured with a pump-to-mounting bracket portion, and having a pump-to-hose connector portion; an elastic pump mounting bracket having a corresponding pump-to-mounting bracket portion configured to couple to the pump-to-mounting bracket portion of the pump in order to couple together the elastic mounting bracket and the pump, and having a system mounting bracket portion connected to the corresponding pump-to-mounting bracket portion to couple to at least some portion of the system, the elastic pump mounting bracket to dampen the transmission of vibration from one end of the pump to the system; and a flexible looped hose connection having a corresponding pump-to-hose connector portion to coupled to the pump-to-hose connector portion of the pump, and having a hose-to-system connector portion to couple to a corresponding hose-to-system connector portion of the system, an intermediate looped hose connection portion to couple together the corresponding pump-to-hose connector portion and the hose-to-system connector portion, the flexible looped hose connection to provide a flow path connection to the system and dampen the transmission of the vibration of the pump to the system via the flow path connection.

### CROSS-REFERENCE TO RELATED APPLICATIONS

This application claims benefit to provisional patent application Ser. No. 62/238,775 (911-005.088-1//F-FLJ-X0024), filed 8 Oct. 2015, which is incorporated by reference in their entirety.

### BACKGROUND OF THE INVENTION

1. Field of Invention

The present invention relates to a technique for mounting a vibrating pumping device; and more particularly relates to a technique for mounting a solenoid pump.

2. Description of Related Art

Typically, solenoid pumps are mounted using spring-isolation or rubber feet in combination with a short straight flexible or rigid connection.

Mounting a solenoid pump to a machine using the above method may allow for significant vibration transmission from the solenoid pump to the machine. This vibration transmission can cause issues with components in the system and will also create unwanted acoustic noise in the environment surrounding the machine.

Using a spring isolator and rubber feet to mount a solenoid pump will reduce the transmission of vibration to a machine, but very often the vibration is transmitted through the pump's flow path connection to the machine. A short straight rigid connection will act as a vibration short circuit to the machine and will almost directly transmit the vibrations generated by the pump into the system in which it is connected.

Using a straight flexible connection from the pump to the machine may be better than a straight rigid connection, but the dampening of the vibration is limited by the length and flexibility of the tube. Very often these pumps are employed due to their small size/pressure generation ratio and space is a limiting factor so using long runs of tube is not possible.

Other problems exist with a straight flexible tube. One issue is that, the more flexible the tubing, the more easily it can radially expand and what is gained in noise reduction from decreasing the vibration transmission to the machine can be made up with noise created by the oscillating radial expansions in the tube. Running a long line of flexible tubing may even increase the acoustic noise produced by the system. Another issue is that as a flexible tube is internally pressurized it will naturally straighten itself out, which is another mode of vibration generation that may again cancel the benefits derived from the use of flexible hose.

In view of this, there is a need in the industry for a better way to mount a vibrating device, e.g., like a solenoid pump, that reduces adverse effects caused by vibration, including the noise caused by the vibration.

### SUMMARY OF THE INVENTION

According to some embodiments, and by way of example, the present invention may include, or take the form of, a new and unique mounting system for mounting a vibrating device (e.g., like a pump) to a system (e.g., like a beverage dispensing system). By way of example, the beverage dispensing system may include, or take the form of, a beverage dispensing machine in a restaurant for dispensing soft drinks like soda, coffee, ice tea, etc. By way of example, the mounting system may take the form of a pump mounting system that features a combination of a pump, at least one elastic pump mounting bracket and a flexible looped hose connection.

The pump may include a housing having a mounting bracket end being configured with a pump-to-mounting bracket portion, and including a pump-to-hose connector portion configured to provide a flow path connection, e.g., between the pump and the system.

The at least one elastic pump mounting bracket may include a corresponding pump-to-mounting bracket portion configured to couple to the pump-to-mounting bracket portion of the pump in order to couple together the at least one elastic mounting bracket and the pump, and may also include a system mounting bracket portion connected to the corresponding pump-to-mounting bracket portion and configured to couple to at least some portion of the system. The at least one elastic pump mounting bracket is configured to dampen the transmission of vibration from a mounting bracket end of the pump to the system.

The flexible looped hose connection may include a corresponding pump-to-hose connector portion configured to coupled to the pump-to-hose connector portion of the pump, may include a hose-to-system connector portion configured to couple to a corresponding hose-to-system connector portion of the system, and may also include an intermediate looped hose connection portion configured to couple together the corresponding pump-to-hose connector portion and the hose-to-system connector portion. The flexible looped hose connection is configured to dampen the transmission of the vibration of the pump to the system via the flow path connection.

By way of example, the system may also include one or more of the following features:

The pump may include, or take the form of, a solenoid pump.

The at least one elastic pump mounting bracket may be configured as a rubber right angled-rectangular mounting foot.

The corresponding pump-to-mounting bracket portion may include, or be formed as, a mounting bracket plate having, or configured with, an aperture for receiving the pump-to-mounting bracket portion of the pump.

The intermediate flexible looped hose connection may include a coiled flexible hose portion having one or more loops, e.g., configured between the corresponding pump-to-hose connector portion and the hose-to-system connector portion.

The corresponding pump-to-hose connector portion and the hose-to-system connector portion may be configured as flexible connectors.

The intermediate flexible looped hose connection may include a rigid U-shaped hose portion having a U-shaped loop, e.g., configured between the corresponding pump-to-hose connector portion and the hose-to-system connector portion.

The pump may be configured with an acoustic foam surrounding at least some portion of the housing of the pump to absorb the acoustic noise generated by the pump.

### Solution to Problem in the Art

This invention takes advantage of a combination of several techniques that are used to decrease the vibration transmission of a pump, e.g., like a solenoid pump, to a system and reduce the acoustic noise output by the system. The key technique is to use a looped or coiled connection to absorb vibration and decrease its transmission from the pump to the system in which the pump operates.

### BRIEF DESCRIPTION OF THE DRAWING

The drawing includes FIGS. 1A-3, which are not necessarily drawn to scale, which are briefly described as follows:

FIG. 1A shows a perspective view of a mounting system, e.g., using one foot and a coiled flexible hose connection, according to some embodiments of the present invention.

FIG. 1B shows a perspective view of an elastic mounting bracket in the form of a rubber foot that may be used for mounting a pump and isolating it from a system, e.g., like a beverage dispensing system, according to some embodiments of the present invention.

FIG. 1C shows a perspective view of the flexible coiled hose connection shown in FIG. 1A that may be used to maximize the length of tubing used in a small or confined area, according to some embodiments of the present invention.

FIG. 2A shows a perspective view of a mounting and connection system, e.g., using one rubber foot and a combined flexible-rigid-flexible looped connection, according to some embodiments of the present invention.

FIG. 2B shows a perspective view of the combined flexible—rigid—flexible connection shown in FIG. 2A that may be used to reduce vibration transmission from a pump to a system, e.g., like a beverage dispensing system, according to some embodiments of the present invention.

FIG. 3 shows a perspective view of an acoustic foam that may be used to absorb acoustic noise output by a pump, according to some embodiments of the present invention.

Not every element or arrow in every Figure is labeled with a lead line and reference numeral/label, so as to reduce clutter in the drawing.

### DETAILED DESCRIPTION OF BEST MODE OF THE INVENTION

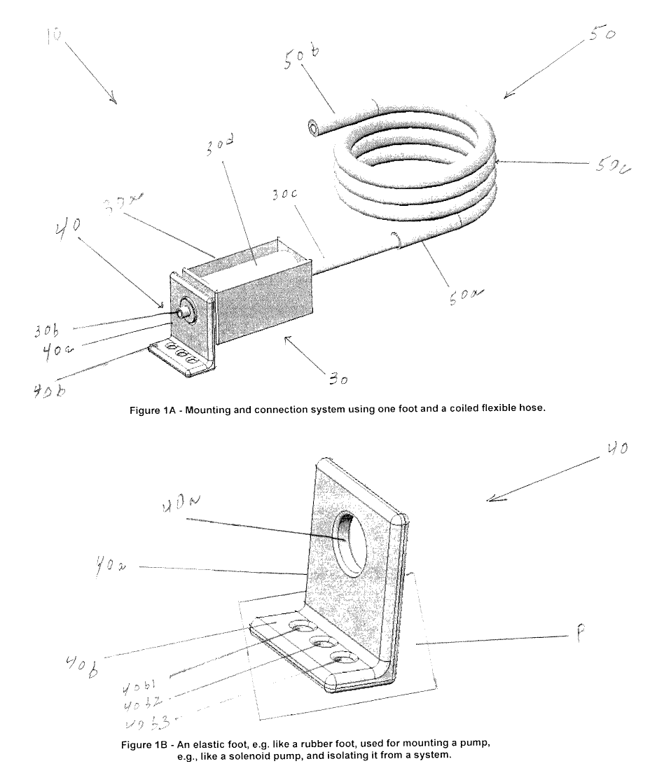

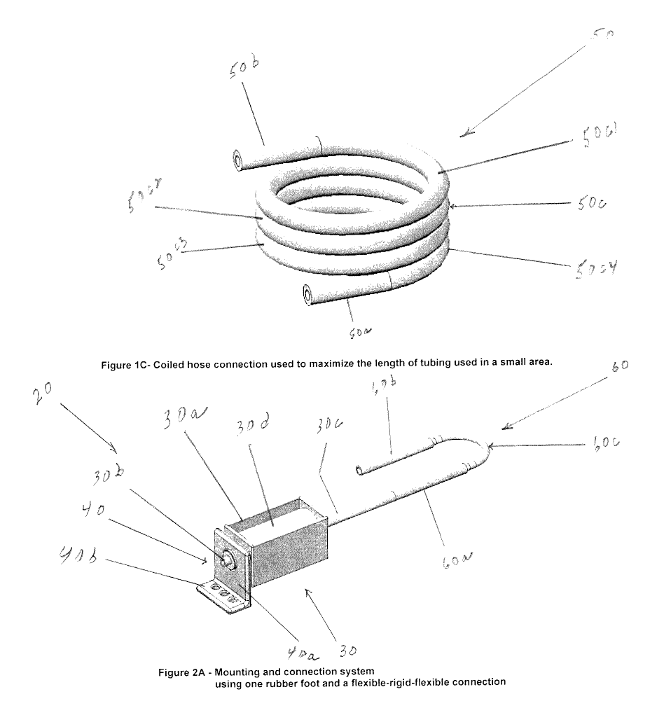

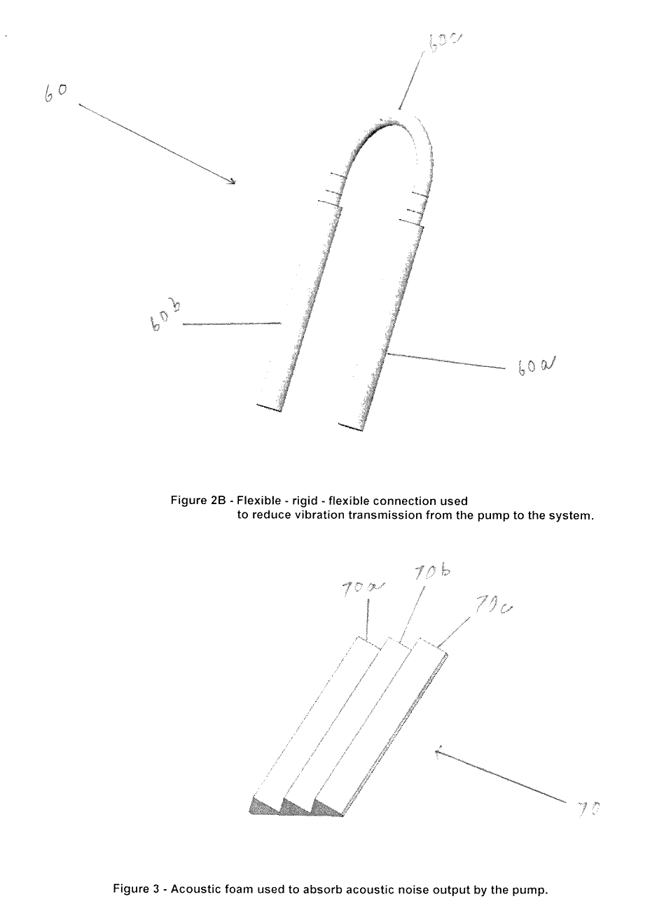

The present invention provides a new and unique technique in which to mount a vibrating pumping device, e.g., like a solenoid pump, into a system (e.g., like a beverage dispensing system) to significantly reduce the transmission of the vibration generated by the pump to that system. By way of example, the present invention may consist of using one or more mounting feet like that shown in FIG. 1B to mount the pump on one end, as well as connecting the pump via a flow connection path to the pumping system using either a coiled, flexible hose having one or more loops, like that shown in FIGS. 1A and 1C, or using a combined flexible-rigid-flexible looped connection, like that shown in FIGS. 2A and 2B. Acoustic noise reducing foam like that shown in FIG. 3 may also be used to reduce the noise generated by the pump.

The one or more mounting feet 40 may be used to dampen the transmission of the vibration generated by the solenoid pump to the system on which the pump is being mounted. By way of example, FIG. 1B shows one of these feet, and FIGS. 1A and 2A show one foot as it would be mounted on at least some portion indicated by the reference P of the system. In the figures, the foot is shown as a right angled-rectangular mounting foot, but the shape of the foot may change depending on the situation or application; and the scope of this invention in not intended to limit the foot to any particular shape.

By way of further example, FIG. 1C shows the coiled hose (aka the flexible looped hose connection) that may be made of a flexible material which acts to dampen the vibrations generated by the vibrating pump. As the vibration generated at the pump travels along the length of the hose, its amplitude decreases. The coil configuration allows for a long length of hose to be included in a limited or confined space. By way of example, FIG. 1A shows the coiled hose as it may be configured or installed in the system.

Alternatively, FIG. 2B shows the combined flexible—rigid—flexible connection (aka the flexible looped hose connection) that allows for a large reduction in the amplitude of a vibration using short lengths of flexible hose to dampen the vibration and isolate the pump from the system and a rigid intermediate connection to alleviate the issues associated with running long lengths of flexible tubing as described in further detail below. This embodiment solves the first issue of radial expansion by limiting the length of hose that will easily expand radially. This embodiment also solves the second problem in the art by breaking up the flexible sections that will want to straighten themselves out as they are pressurized. As one portion of the flexible tubing straightens, it will create bending in the other section instead of transmitting the force to the system on which the pump is connected. The connections shown in FIGS. 2A and 2B use straight flexible end connections and a U shaped intermediate rigid connection arranged inbetween; however, the embodiment shown in the figures are by way of example, and are not meant to limit the connection to this specific configuration.

Further to the connection and mounting methods, acoustic foam can be added in the areas in the system which surround the pump to absorb the acoustic noise generated by the pump. It may also be used to route the hose or other connections being used in the system. FIG. 3 shows an example of noise reducing foam, e.g., having a series of ridges.

### The Pump Mounting System 10, 20

By way of example, FIGS. 1A and 2A show pump mounting systems generally indicated as 10 and 20, each featuring a combination of a pump 30, at least one elastic pump mounting bracket 40 and a flexible looped hose connection 50, 60.

The pump 30 may include a housing 30a having a mounting bracket end configured with a pump-to-mounting bracket portion 30b, and may also include a pump-to-hose connector portion 30c configured to provide a flow path connection, e.g., which may take the form of a conduit or hosing coupled to a fluid outlet port for providing a fluid being pumped in the system like a beverage dispensing system. By way of example, the pump-to-mounting bracket portion 30b may include, or take the form of, a fastener (e.g., a nut) and a rubber washer or grommet for connecting to a screw or bolt extending from the housing 30a. Alternatively, the pump-to-mounting bracket portion 30b may include, or take the form of, a corresponding fastener (e.g., a bolt or screw) for connecting to threading formed in the housing 30a. The scope of the invention is not intended to be limited to the manner or way in which the pump-to-mounting bracket portion 30b is coupled to the housing 30a.

By way of further example, the beverage dispensing system may include, or take the form of, a beverage dispensing machine in a restaurant or convenience store. The pump 30 may also include a pumping unit 30d for pumping the fluid, e.g., from the pump's inlet to the pump's outlet. Embodiments are envisioned, and the scope of the invention is intended to include, e.g., using the present invention in relation to a flow path connection configured on the pump's inlet, on the pump's outlet, or some combination thereof.

The elastic pump mounting bracket 40 may include a corresponding pump-to-mounting bracket portion 40a configured to couple to the pump-to-mounting bracket portion 30b of the pump 30 in order to couple together the elastic mounting bracket 40 and the pump 30. The elastic pump mounting bracket 40 may also include a system mounting bracket portion 40b connected to the corresponding pump-to-mounting bracket portion 40a and configured to couple to at least some portion generally indicated as P of the system. The portion P may include, e.g., a pump mounting wall or shelving that forms part of the system's housing. The elastic pump mounting bracket 40 may be configured to dampen the transmission of vibration from the mounting bracket end of the pump 30 to that portion P of the system.

The flexible looped hose connection 50, 60 may include a corresponding pump-to-hose connector portion 50a, 60a configured to couple to the pump-to-hose connector portion 30c of the pump 30. The flexible looped hose connection 50, 60 may also include a hose-to-system connector portion 50b, 60b configured to couple to a corresponding hose-to-system connector portion (not shown) of the system, e.g., like a corresponding conduit or hosing. The flexible looped hose connection 50, 60 may also include an intermediate looped hose connection portion 50c, 60c configured to couple together the corresponding pump-to-hose connector portion 50a, 60a and the hose-to-system connector portion 50b, 60b so as to form the flexible looped hose connection 50, 60. The flexible looped hose connection 50, 60 is configured to dampen the transmission of the vibration of the pump to the system via the flow path connection. By way of example, the corresponding hose-to-system connector portion (not shown) may form a part of the beverage dispensing system for providing the fluid from the pump 30 to some dispensing output for dispensing the fluid from the beverage dispensing system, as well as for receiving the fluid to be pumped by the pump 30 from a fluid storage for providing the fluid to the beverage dispensing system. By way of example, the fluid storage may include, or take the form of, a bag of beverage syrup, or some hosing for providing water to be combined with the beverage syrup, etc. By way of example, the flexible looped hose connection 50, 60 may be made, or manufactured, as a single integral plastic injection molded piece. Alternatively, and by way of further example, the flexible looped hose connection 50, 60 may be made, or manufactured, as separate pieces that are coupled together, e.g., having a separate corresponding pump-to-hose connector portion 50a, 60a, a separate hose-to-system connector portion 50b, 60b and a separate intermediate looped hose connection portion 50c, 60c. The scope of the invention is not intended to be limited to any particular type, kind or manner of making or manufacturing the flexible looped hose connection 50, 60, the manner in which the separate components are coupled together, or the type or kind of materials that are used to make or manufacture the same.

As shown in FIGS. 1A, 1B and 2A, the elastic pump mounting bracket 40 may be configured as a right angled-rectangular mounting foot, and may be made of rubber. However, embodiments are envisioned, and the scope of the invention is intended to include, e.g., using other non-right angled configurations and/or other elastic materials within the spirit of the present invention.

The corresponding pump-to-mounting bracket portion 40a may take the form of a rubber mounting bracket plate, e.g., having, or configured with, an aperture 40a′ for receiving the pump-to-mounting bracket portion 30b of the pump 30. The system mounting bracket portion 40b may be configured with one or more apertures like the elements identified by reference labels 40b1, 40b2, 40b3 for receiving fasteners (not shown) for coupling the elastic mounting bracket 40 to the portion P of the system. However, embodiments are envisioned, and the scope of the invention is intended to include, e.g., using other types or kinds of coupling techniques for coupling the elastic mounting bracket 40 and the pump 30 together, as well as for coupling the mounting bracket portion 40b and the portion P of the system together, within the spirit of the present invention.

The intermediate looped hose connection portion 50c, 60c may include a coiled flexible hose portion 50c having one or more loops 50c1, 50c2, 50c3, 50c4, e.g., being configured between, and coupled to, the corresponding pump-to-hose connector portion 50a and the hose-to-system connector portion 50b. The scope of the invention is not intended to be limited to the number of loops, or the length of the loops, or the diameter of the loops, etc., e.g., which may depend and be configured based upon the requirements of a particular application.

The corresponding pump-to-hose connector portion 50a, 60a and the hose-to-system connector portion 50b, 60b may be configured as flexible connectors, e.g., like that shown in FIGS. 1A, 1C, 2A and 2B. However, embodiments are envisioned, and the scope of the invention is intended to include, e.g., where one or more of the corresponding pump-to-hose connector portion 50a, 60a and the hose-to-system connector portion 50b, 60b are rigid (i.e., non-flexible) connectors.

Alternatively, the flexible looped hose connection 50, 60 may include a rigid U-shaped hose portion 60c having a U-shaped loop, e.g., being configured between the corresponding pump-to-hose connector portion 60a and the hose-to-system connector portion 60b. The scope of the invention is not intended to be limited to the length of the U-shape, etc., e.g., which may depend and be configured based upon the requirements of a particular application.

The pump mounting systems 10, 20 may also be configured with an acoustic foam 70, e.g., surrounding at least some portion of the housing 30a of the pump 30 to absorb the acoustic noise generated by the pump. By way of example, in FIG. 3 the acoustic foam 70 is shown having a saw tooth configuration having ridges 70a, 70b, 70c.

### A Loop or Coil

By way of example, the term “loop” is understood to mean a shape produced by a curve that bends at least partially around, e.g., forming at least a U-shape, as shown by the U-shaped hose connection in FIGS. 1C and 2B.

By way of example, the term “coil” is understood to mean a shape produced by a series of loops, e.g., having curves that bend at least completely around, e.g., forming at least a ring or spiral, as shown by the coiled hose connection in FIGS. 1A and 1C.

The hose connections shown in FIGS. 1A, 1C, 2A and 2B are understood to be flexible looped hose connections, e.g., consistent with that disclosed herein and consistent with the aforementioned understanding of these terms “loop” and “coil”.

### Possible Applications

This technology according to the present invention could be used in any application in which vibration or acoustic noise reduction from a vibrating pumping device, e.g., like a solenoid pump, is desired. For example, applications may also include pumps or pumping devices, e.g., like compressors. By way of example, the present invention may take the form of a mounting system for mounting a vibrating pumping device to a system, e.g., where the vibrating pumping device may include any vibrating pumping device like a pump, a solenoid pump or a compressor.

### The Scope of the Invention

While the invention has been described with reference to an exemplary embodiment, it will be understood by those skilled in the art that various changes may be made and equivalents may be substituted for elements thereof without departing from the scope of the invention.

In addition, may modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

What is claimed is:

1. A pump mounting system for mounting a pump to a system, including a beverage dispensing system, comprising:
a pump having a housing with a mounting bracket end being configured with a pump-to-mounting bracket portion, and having a pump-to-hose connector portion configured to provide a flow path connection;
at least one elastic pump mounting bracket having a corresponding pump-to-mounting bracket portion configured to couple to the pump-to-mounting bracket portion of the pump in order to couple together the at least one elastic mounting bracket and the pump, and having a system mounting bracket portion connected to the corresponding pump-to-mounting bracket portion and configured to couple to at least some portion of the system, the at least one elastic pump mounting bracket configured to dampen the transmission of vibration from the mounting bracket end of the pump to the system; and
a flexible looped hose connection having a corresponding pump-to-hose connector portion configured to coupled to the pump-to-hose connector portion of the pump, and having a hose-to-system connector portion configured to couple to a corresponding hose-to-system connector portion of the system, an intermediate looped hose connection portion configured to couple together the corresponding pump-to-hose connector portion and the hose-to-system connector portion, the flexible looped hose connection configured to dampen the transmission of the vibration of the pump to the system via the flow path connection.

2. A pump mounting system according to claim 1, wherein the pump is a solenoid pump.

3. A pump mounting system according to claim 1, wherein the at least one elastic pump mounting bracket is configured as a rubber right angled-rectangular mounting foot.

4. A pump mounting system according to claim 1, wherein the corresponding pump-to-mounting bracket portion comprises a mounting bracket plate having, or configured with, an aperture for receiving the pump-to-mounting bracket portion of the pump.

5. A pump mounting system according to claim 1, wherein the intermediate flexible looped hose connection includes a coiled flexible hose portion having one or more loops configured between the corresponding pump-to-hose connector portion and the hose-to-system connector portion.

6. A pump mounting system according to claim 5, wherein the corresponding pump-to-hose connector portion and the hose-to-system connector portion are configured as flexible connectors.

7. A pump mounting system according to claim 1, wherein the flexible looped hose connection includes a rigid U-shaped hose portion having a U-shaped loop configured between the corresponding pump-to-hose connector portion and the hose-to-system connector portion.

8. A pump mounting system according to claim 7, wherein the corresponding pump-to-hose connector portion and the corresponding hose-to-system connector portion are configured as flexible connectors.

9. A pump mounting system according to claim 1, wherein the pump is configured with an acoustic foam surrounding the housing of the pump to absorb the acoustic noise generated by the pump.

10. A mounting system for mounting a vibrating pumping device to a system, comprising:
a vibrating pumping device having a housing with a mounting bracket end and being configured with a vibrating-pumping-device-to-mounting bracket portion, and having a vibrating-pumping-device-to-hose connector portion configured to provide a flow path connection;
at least one elastic mounting bracket having a corresponding vibrating-pumping-device-to-mounting bracket portion configured to couple to the vibrating-pumping-device-to-mounting bracket portion of the vibrating in order to couple together the at least one elastic mounting bracket and the vibrating pumping device, and having a system mounting bracket portion connected to the corresponding vibrating-pumping-device-to-mounting bracket portion and configured to couple to a corresponding system mounting bracket portion of the system, the at least one elastic mounting bracket configured to dampen the transmission of vibration from one end of the vibrating pumping device to the system; and
a flexible looped hose connection having a corresponding vibrating-pumping-device-to-hose connector portion configured to coupled to the vibrating-pumping-device-to-hose connector portion of the vibrating device, and having a hose-to-system connector portion configured to couple to a corresponding hose-to-system connector portion of the system, an intermediate looped hose connection portion configured to couple together the corresponding vibrating-pumping-device-to-hose connector portion and the hose-to-system connector portion, the flexible looped hose connection configured to provide a flow path connection to the system and dampen the transmission of the vibration of the vibrating pumping device to the system.

11. A mounting system according to claim 10, wherein the vibrating pumping device is a solenoid pump.

12. A mounting system according to claim 10, wherein the vibrating pumping device is a vibrating pump.

13. A mounting system according to claim 10, wherein the vibrating pumping device is a compressor.

14. A mounting system according to claim 10, wherein the intermediate flexible looped hose connection includes a coiled flexible hose portion having one or more loops configured between the corresponding pump-to-hose connector portion and the hose-to-system connector portion.

15. A mounting system according to claim 14, wherein the corresponding pump-to-hose connector portion and the hose-to-system connector portion are configured as flexible connectors.

16. A mounting system according to claim 10, wherein the flexible looped hose connection includes a rigid U-shaped hose portion having a U-shaped loop configured between the corresponding pump-to-hose connector portion and the hose-to-system connector portion.

17. A mounting system according to claim 16, wherein the corresponding pump-to-hose connector portion and the hose-to-system connector portion are configured as flexible connectors.

18. A beverage dispensing system having a pump mounting system, the pump mounting system comprising:
a solenoid pump having a housing with a mounting bracket end being configured with a pump-to-mounting bracket portion, and having a pump-to-hose connector portion configured to provide a flow path connection;
at least one elastic pump mounting bracket having a corresponding pump-to-mounting bracket portion configured to couple to the pump-to-mounting bracket portion of the solenoid pump in order to couple together the at least one elastic mounting bracket and the solenoid pump, and having a system mounting bracket portion connected to the corresponding pump-to-mounting bracket portion and configured to couple to at least some portion of the system, the at least one elastic pump mounting bracket configured to dampen the transmission of vibration from the mounting bracket end of the solenoid pump to the system; and
a flexible looped hose connection having a corresponding pump-to-hose connector portion configured to coupled to the pump-to-hose connector portion of the solenoid pump, and having a hose-to-system connector portion configured to couple to a corresponding hose-to-system connector portion of the system, an intermediate looped hose connection portion configured to couple together the corresponding pump-to-hose connector portion and the hose-to-system connector portion, the flexible looped hose connection configured to dampen the transmission of the vibration of the solenoid pump to the system via the flow path connection.

19. A beverage dispensing system according to claim 18, wherein
the intermediate flexible looped hose connection includes a coiled flexible hose portion having one or more loops configured between the corresponding pump-to-hose connector portion and the hose-to-system connector portion; and
the corresponding pump-to-hose connector portion and the hose-to-system connector portion are configured as flexible connectors.

20. A beverage dispensing system according to claim 18, wherein
the flexible looped hose connection includes a rigid U-shaped hose portion having a U-shaped loop configured between the corresponding pump-to-hose connector portion and the hose-to-system connector portion; and
the corresponding pump-to-hose connector portion and the hose-to-system connector portion are configured as flexible connectors.
